(19) United States
(12) Patent Application Publication
(10) Pub. No.: US 2018/0186350 A1
(43) Pub. Date: Jul. 5, 2018

(54) EMERGENCY BRAKE ASSIST SYSTEM FOR A VEHICLE

(71) Applicant: Conti Temic microelectronic GmbH, Nürnberg (DE)

(72) Inventors: Mario Götz, Jettingen (DE); Muhammad Alrefai, Lauffen am Neckar (DE); Mihai Baneu, Lindau (DE); Helmut Steurer, Junkenhofen/Geroisbach (DE); Armin Vogl, Obergriesbach (DE)

(73) Assignee: Conti Temic microelectronic GmbH, Nürnberg (DE)

(21) Appl. No.: 15/908,010

(22) Filed: Feb. 28, 2018

Related U.S. Application Data
(63) Continuation of application No. PCT/DE2016/200401, filed on Aug. 26, 2016.

(30) Foreign Application Priority Data
Sep. 1, 2015 (DE) 10 2015 216 679.1

(51) Int. Cl. B60T 7/22; B60W 30/09

(52) U.S. Cl. CPC B60T 7/22; B60W 30/09; B60W 2720/106; B60T 2201/024; B60T 2201/022

(57) ABSTRACT

An improved emergency braking assist system for a vehicle takes account of the region to the rear when specifying emergency braking parameters. The region to the rear is also monitored and the emergency braking parameters optionally adapted during the emergency braking operation.

### CROSS REFERENCE TO RELATED APPLICATION

This application is a continuation of International application No. PCT/DE2016/200401, filed Aug. 26, 2016, which claims priority to German application No. 10 2015 216 679.1, filed on Sep. 1, 2015, each of which is hereby incorporated by reference.

### TECHNICAL FIELD

The technical field relates generally to an emergency braking assist system for a vehicle.

### BACKGROUND

Driving environment monitoring systems are increasingly used in vehicles. The information detected by these systems may be used inter alia for automatic emergency braking of the vehicle. However, the performance of emergency braking is always associated with a risk to the traffic following behind. The data detected by driving environment monitoring systems must therefore be reliable and emergency braking must take place within optimum limits, in order to prevent a collision on the one hand with an object in front of the vehicle and on the other hand with a vehicle following behind.

DE 10 2010 029 223 A1 discloses a mathematical model which is used to abort an emergency braking operation initiated according to the prior art or to reduce braking force, so as to limit the collision severity of a future rear-end collision and at the same time achieve sufficient braking action.

### BRIEF SUMMARY

In one exemplary embodiment, a method for automatic emergency braking of a vehicle includes detecting an object in the regions in front of and behind the vehicle and specifying at least one emergency braking parameter as a function of at least one detected object in the region in front of the vehicle. The at least one emergency braking parameter is modified if no object, in particular no travelling following vehicle, is detected in the region behind the vehicle.

In this way, emergency braking may advantageously proceed with the optimum parameters if there is no object in the region behind the vehicle, since traffic to the rear does not have to be taken into consideration.

The emergency braking parameters may include a permissible speed range within which the emergency braking assist system is active, or a deceleration requirement, or a speed reduction, or the time of emergency braking.

Advantageously, the speed range or the deceleration requirement or the speed reduction may be set to an optimum value in order to prevent a collision with the object in front of the vehicle or to reduce collision severity. An optimum value could, for example, be the maximum possible deceleration power of the vehicle's brakes. Optimum values for the speed range are inter alia the values for standard urban and extra-urban speed limits, i.e., the ranges 30-50, 70-100, and 130 km/h. In particular, emergency braking may proceed in any speed range, since there is no risk of a rear-end collision due to the absence of objects in the region to the rear.

The emergency braking parameters may be modified as follows: the permissible speed range is increased or the deceleration requirement is increased or the speed reduction is increased or the time of emergency braking is brought forward.

It may be more advantageous for the time of emergency braking to be brought forward, so as to have more time for decelerating the vehicle. Harm to other road users is ultimately ruled out by the object identification in the region to the rear.

In a further exemplary configuration, object detection in the region behind the vehicle may proceed continuously. This advantageously makes it possible to anticipate that the region behind the vehicle is free of further objects and emergency braking may be carried out with modified or increased emergency braking parameters. In this way, in particular, the region to the rear may also be monitored during emergency braking.

The increase in at least one of the emergency braking parameters may be maintained until an object, in particular a travelling following vehicle, is detected in the region behind the vehicle.

An object identified in this way in the region to the rear before or during emergency braking may be taken into consideration and the initiation or continuation of emergency braking may be adapted to changing traffic situations. In particular, the increased emergency braking parameters may be cancelled and the basic parameters applied.

In one exemplary configuration, object detection in the region behind the vehicle may determine a relative speed or a distance of the detected object. The distance and relative speed may give an indication of the future behaviour of the object following behind and thus of the emergency braking parameters to be taken into account during subsequent emergency braking.

It is thus possible in particular to examine each traffic situation individually and for emergency braking to proceed with emergency braking parameters tailored to the object following behind.

In another exemplary configuration, the increase in at least one emergency braking parameter may proceed dynamically with the relative speed or the distance of the detected object.

Adaptation of the emergency braking parameters may proceed continuously during emergency braking, the emergency braking parameters in this way being adapted to the emergency braking behaviour of the vehicle itself or to the behavior of the object following behind.

In one exemplary configuration, evasive action may be performed if a collision with the detected object in the region in front of the vehicle and the detected object in the region behind the vehicle, in particular a travelling following vehicle, is no longer preventable by emergency braking.

Evasive action may be initiated if it is ascertained during emergency braking that braking to avoid an accident with the obstacle or the object following behind can no longer be prevented despite adaptation of the emergency braking parameters. Pointless emergency braking of the vehicle may in particular be avoided in this way.

In one exemplary embodiment, an emergency braking assist system for a vehicle includes an object detection unit for the region in front of and behind the vehicle, and a control unit for carrying out a method as described above, wherein the control unit includes an electronic memory on which the method may be stored.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 shows a traffic situation with a plurality of vehicles according to an exemplary embodiment;

FIG. 2 shows a flow diagram for operation of an emergency braking assist system according to an exemplary embodiment;

FIG. 3 shows a diagram of a curve of an emergency braking parameter according to an exemplary embodiment; and

FIG. 4 shows an emergency braking unit for a vehicle according to an exemplary embodiment.

### DETAILED DESCRIPTION

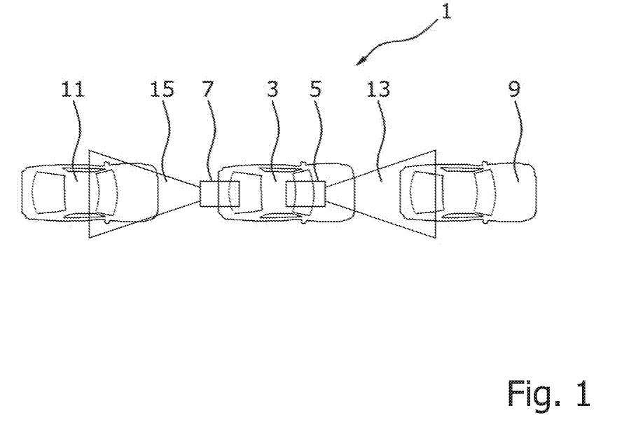

FIG. 1 shows a traffic situation 1 with a plurality of vehicles 3, 9, 11. The middle vehicle 3 is provided with object detection units 5, 7 for both the region in front of 13 and behind 15 the vehicle 3. The respective object detection unit detects objects in front of 13 and behind 15 the vehicle 3, if objects 9, 11, or vehicles are located in these regions.

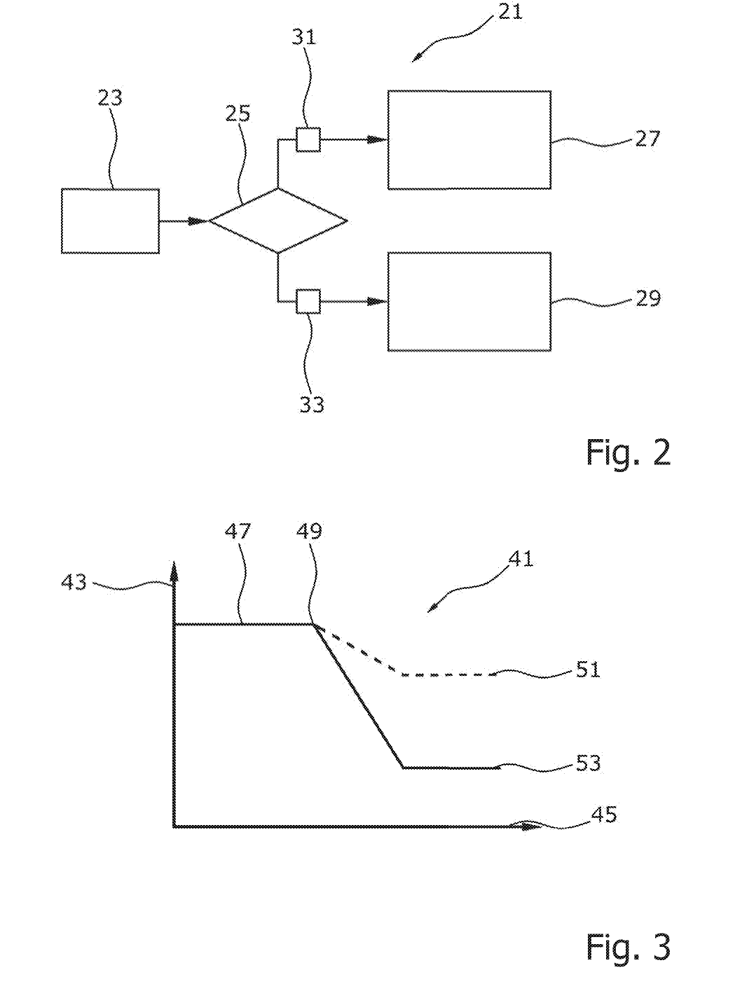

FIG. 2 shows a flow diagram for operation 21 of an emergency braking assist system. The object detection unit 23 monitors the region to the rear of the vehicle and looks for objects in this region 25. If objects are identified 31, the specified basic parameters 27 are used as emergency braking parameters for the emergency braking. If, on the other hand, no objects are identified 33 in the region 25 to the rear, any emergency braking that is initiated is carried out with optimum parameters 29, parameters which are optimally increased compared with the basic parameters, as the emergency braking parameters.

The method shown in FIG. 2 for operation 21 of the emergency braking assist system is also carried out during emergency braking which is already taking place. Should the object detection unit 23 identify 31 an object in the region 25 to the rear after the emergency braking operation has begun, the emergency braking is continued with the basic parameters 27. The increased optimum parameters 29 are therefore no longer used. Instead of immediately using the basic parameters 27, intermediate parameters which lie between the optimum parameters 29 and the basic parameters 27 may also be used.

FIG. 3 shows a diagram of the curve of an emergency braking parameter 41. For example, the curve of the permitted speed reduction (in km/h) 43 is plotted against time (msec) 45. At the beginning, no object is identified in the region to the rear and any emergency braking that may take place would be carried out 47 with the optimum parameters increased over the basic parameters.

At the point in time 49 the object detection system detects an object in the region to the rear of the vehicle and reduces the permitted speed reduction back to the basic parameters 53 dynamically as a function of the speed and distance of the identified object. The adjustment proceeds dynamically, such that intermediate parameters, shown for example by the dashed line 51, between the optimum parameters and the basic parameters may also be adopted.

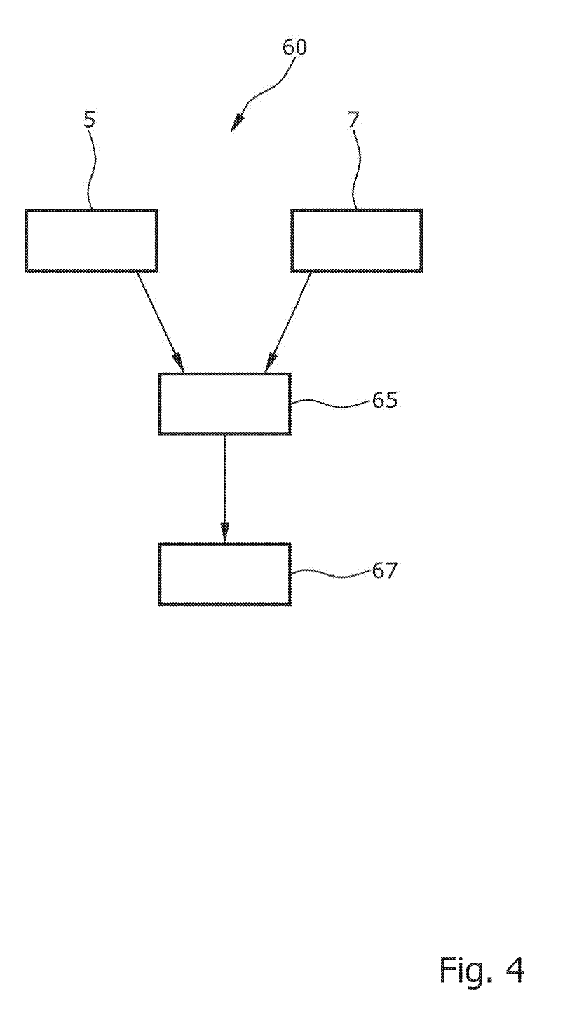

FIG. 4 shows an emergency braking unit 60 for a vehicle. The object detection units 5, 7 for the regions in front of 13 and behind 15 the vehicle monitor the respective traffic space and determine the relative speed and the distance of the identified objects 11, 9. The control unit 65 then adapts the emergency braking parameters to the identified objects and controls the braking system 67 of the vehicle accordingly.

The present disclosure has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. An automatic emergency braking method for a vehicle, comprising:
detecting an object in the regions in front of and behind the vehicle;
specifying at least one emergency braking parameter as a function of at least one detected object in the region in front of the vehicle; and
modifying the at least one emergency braking parameter in response to no object being detected in the region behind the vehicle.

2. The method as set forth in claim 1, wherein modifying the at least one emergency braking parameter includes modifying the at least one emergency braking parameter in response to no following vehicle being detected behind the vehicle.

3. The method as set forth in claim 1, wherein the at least one emergency braking parameter is at least one of the following:
a permissible speed range within which the emergency braking assist system is active;
a deceleration requirement;
a speed reduction; and
a time of emergency braking.

4. The method as set forth in claim 3, wherein modifying the emergency braking parameter comprises at least one of:
increasing the permissible speed range;
increasing the deceleration requirement;
increasing the speed reduction; and
bringing forward the time of emergency braking.

5. The method as set forth in claim 1, wherein object detection in the region behind the vehicle proceeds continuously.

6. The method as set forth in claim 1, wherein the modification of at least one of the emergency braking parameters is maintained until an object is detected in the region behind the vehicle.

7. The method as set forth in claim 6, wherein the object detection in the region behind the vehicle determines a relative speed or a distance of the detected objects.

8. The method as set forth in claim 7, wherein the increase in at least one of the emergency braking parameters is modified dynamically with the relative speed or the distance of the detected object.

9. The method as set forth in claim 6, wherein evasive action is performed if a collision with the detected object in the region in front of the vehicle and the detected object in the region behind the vehicle is no longer preventable by emergency braking.

10. An emergency braking assist system for a vehicle, comprising:
an object detection unit for the region in front of and behind the vehicle; and
a control unit including an electronic memory for storing and carrying out an automatic emergency braking method, the method comprising:
detecting an object in the regions in front of and behind the vehicle;
specifying at least one emergency braking parameter as a function of at least one detected object in the region in front of the vehicle; and
modifying the at least one emergency braking parameter in response to no object being detected in the region behind the vehicle.
